(19) United States
(12) Patent Application Publication
(10) Pub. No.: US 2026/0362166 A1
(43) Pub. Date: Nov. 12, 2026

(54) SYSTEMS AND METHODS FOR DISTRIBUTED EDGE AI NETWORK MANAGEMENT AND CONTROL

(71) Applicant: PLUME DESIGN, INC., Palo Alto, CA (US)

(72) Inventors: Richard CHANG, Los Altos Hills, CA (US); Albert LIU, Hsinchu (TW); JianShing Sean LI, Campbell, CA (US); Miroslav SAMARDZIJA, Mountain View, CA (US); Dinh Hieu Liem VO, Saratoga, CA (US); Ha DO, Cumming, GA (US); Jeffrey CHAO, San Jose, CA (US); Cuong VU, Newark, CA (US); Xiaowei QIAN, Suzhou, Jiangsu (CN); Cooper CHEN, Hsinchu (TW); James WU, Hsinchu (TW)

(21) Appl. No.: 19/299,531

(22) Filed: Aug. 14, 2025

Related U.S. Application Data
(60) Provisional application No. 63/804,604, filed on May 12, 2025.

(51) Int. Cl. H04W 24/02; H04W 24/08

(52) U.S. Cl. CPC H04W 24/02; H04W 24/08

(57) ABSTRACT

Disclosed are computerized systems and methods for a decision intelligence (DI)-based framework that automatically and/or dynamically provides mechanisms for managing, optimizing and configuring a wireless network at a location. The framework provides distributed edge computing mechanisms for smart home network and device management. The framework leverages existing home network infrastructure—including Wi-Fi routers, mesh nodes, and connected devices—to form a localized, elastic computing cluster capable of executing AI workloads with low latency and enhanced privacy. AI tasks can be dynamically allocated across devices based on real-time capacity, enabling scalable processing and fault tolerance. The framework supports multiple simultaneous applications such as personalized Wi-Fi optimization, device classification, occupancy sensing, and IoT automation, with local data processing ensuring privacy.

### CROSS-REFERENCE TO RELATED APPLICATIONS

This application claims the benefit of priority from U.S. Provisional Application No. 63/804,604, filed May 19, 2025, whereby the contents of which are incorporated by reference in its entirety.

### FIELD OF THE DISCLOSURE

The present disclosure provides a decision intelligence (DI)-based computerized framework for automatically and/or dynamically managing, optimizing and configuring a wireless network at a location.

### SUMMARY OF THE DISCLOSURE

According to some embodiments, as discussed herein, the disclosed systems and methods provide a computerized, network management and configuration framework that operates by utilizing edge processing capabilities to bridge local Wireless Fidelity (Wi-Fi or WiFi, used interchangeably) and cloud systems.

According to some embodiments, as evidenced from the disclosure herein, the disclosed framework represents a paradigm shift in smart home artificial intelligence (AI) and network/device management, by implementing a distributed edge computing architecture that transforms existing home network infrastructure into an intelligent, adaptive system. Rather than relying on cloud-based processing, the framework can leverage the computational resources already present in modern homes—including Wi-Fi routers, mesh nodes, set-top boxes, and other connected devices—to create a localized AI processing cluster that operates with minimal latency and enhanced privacy protection.

In some embodiments, the framework can establish what may be termed “elastic edge computing,” where AI workloads are dynamically distributed across available home devices based on computational capacity and current load. Such approach can enable the framework to scale processing power incrementally as new devices join the network, while maintaining fault tolerance through distributed redundancy. In some embodiments, the framework can orchestrate these resources through an advanced coordination mechanism that treats each participating device as a node in a local compute cluster, effectively creating a miniaturized cloud environment within the home.

In some embodiments, the technical architecture of the framework can support multiple AI-driven applications simultaneously, including personalized Wi-Fi optimization, device classification and management, advanced parental controls, occupancy sensing through Wi-Fi signal analysis, and comprehensive Internet of Things (IoT) automation. Each of these applications can benefit from the framework's ability to process data locally, enabling real-time responses while maintaining data privacy by keeping sensitive information within the home environment.

In some embodiments, the framework can implement federated learning principles, where local AI models train on household-specific data while contributing anonymized insights to a broader knowledge base. Such approach can enable the framework to benefit from collective learning across multiple deployments while preserving individual privacy. In some embodiments, local models can adapt to specific household patterns and preferences, while periodic synchronization with cloud-based aggregated models can enhance overall system intelligence without compromising personal data security.

According to some embodiments, from a deployment perspective, the framework can operate on existing hardware through containerized applications, eliminating the need for specialized AI processing units or extensive hardware upgrades. In some embodiments, the framework can run efficiently on standard router processors, leveraging spare computational cycles during periods of low network activity. Such hardware-agnostic approach can enable widespread deployment across diverse device ecosystems without requiring significant infrastructure investment.

In some embodiments, the framework's modular architecture can support extensibility through well-defined APIs and integration points, allowing third-party applications to leverage the distributed computing infrastructure and sensor data streams. Such extensibility can enable service providers to develop custom applications tailored to specific market segments or user requirements while maintaining the core intelligence and optimization capabilities of the underlying platform.

According to some embodiments, it should be understood that reference to a location can refer to any type of known or to be known geographic area, building, structure or area for which wireless connectivity can be provided, which can include, but is not limited to, a home, office, building, patio, and the like, without departing from the scope of the instant disclosure.

According to some embodiments, a method is disclosed for automatically and/or dynamically managing, optimizing and configuring a wireless network at a location. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for automatically and/or dynamically managing, optimizing and configuring a wireless network at a location.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 illustrates an exemplary workflow according to some embodiments of the present disclosure;

FIG. 5 illustrates an exemplary workflow according to some embodiments of the present disclosure;

FIG. 6 illustrates an exemplary workflow according to some embodiments of the present disclosure;

FIG. 7 depicts an exemplary implementation of an architecture according to some embodiments of the present disclosure;

FIG. 8 depicts an exemplary implementation of an architecture according to some embodiments of the present disclosure; and

FIG. 9 is a block diagram illustrating a computing device showing an example of a client or server device used in some embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some embodiments, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth™, 802.11b/a/g/n/ac/ax/be, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures.

According to some embodiments, as discussed herein, disclosed is a distributed edge computing framework for smart home network and device management. The framework leverages existing home network infrastructure—including Wi-Fi routers, mesh nodes, and connected devices—to form a localized, elastic computing cluster capable of executing AI workloads with low latency and enhanced privacy. AI tasks are dynamically allocated across devices based on real-time capacity, enabling scalable processing and fault tolerance. The framework supports multiple simultaneous applications such as personalized Wi-Fi optimization, device classification, occupancy sensing, and IoT automation, with local data processing ensuring privacy. Federated learning allows local models to adapt to household-specific data while contributing anonymized updates to a shared knowledge base. The framework operates on standard hardware using containerized applications and exposes modular APIs for third-party integration, facilitating broad deployment without requiring specialized hardware upgrades.

### Wi-Fi Optimization

According to some embodiments, the disclosed Wi-Fi optimization capabilities of the framework represent an advanced application of AI and/or machine learning (ML) to network performance management, moving beyond traditional static configuration approaches to implement dynamic, learning-based optimization strategies. The framework can continuously monitor network conditions, device behavior, and usage patterns to develop highly personalized optimization strategies that adapt to the unique characteristics of each home environment.

In some embodiments, the framework can implement multi-dimensional learning algorithms that analyze historical usage patterns, device capabilities, and environmental factors to predict optimal network configurations. These algorithms can process data streams including channel utilization metrics, signal strength measurements, interference patterns, device association histories, and application-specific performance indicators. By correlating these data points over time, the framework can identify subtle patterns that would be invisible to traditional rule-based optimization systems.

In some embodiments, the framework can perform real-time spectrum analysis across all available frequency bands, utilizing advanced signal processing techniques to identify optimal channel assignments that minimize interference while maximizing throughput. Unlike conventional systems that may perform periodic channel scans, the framework can maintain continuous awareness of spectrum conditions through passive monitoring techniques that analyze ongoing transmissions without disrupting network operations. Such continuous monitoring capability can enable the framework to detect interference sources, neighboring network changes, and environmental factors that impact signal propagation.

In some embodiments, for band steering optimization, the framework can implement advanced client classification algorithms that analyze device capabilities, current applications, and mobility patterns to determine optimal frequency band assignments. In some embodiments, the framework can recognize when devices are engaged in bandwidth-intensive activities such as video streaming or video conferencing and can proactively steer these devices to less congested channels or higher-capacity frequency bands. In some embodiments, the framework can also implement predictive steering, where devices are moved to optimal bands based on anticipated usage patterns learned from historical data.

In some embodiments, Quality of Service (QoS) and/or Quality of Experience (QoE) optimization within the framework can extend beyond simple traffic prioritization to implement application-aware resource allocation. In some embodiments, the framework can identify different types of network traffic through deep packet inspection and behavioral analysis, enabling it to distinguish between real-time applications requiring low latency, bulk data transfers that can tolerate higher latency, and interactive applications requiring balanced performance characteristics. Based on such classification, the framework can dynamically adjust transmission parameters, airtime allocation, and buffering strategies to optimize the user experience for each application type.

In some embodiments, the framework can implement adaptive mesh topology optimization for multi-node deployments, analyzing backhaul link quality, client distribution, and coverage patterns to determine optimal mesh configurations. In some embodiments, the framework can dynamically adjust node roles, transmission power levels, and inter-node communication patterns to maintain optimal coverage while minimizing self-interference. When environmental changes occur—such as furniture rearrangement or seasonal variations in signal propagation—the framework can automatically reconfigure the mesh topology to maintain optimal performance.

In some embodiments, load balancing capabilities within the framework can extend beyond simple client count distribution to implement intelligent resource allocation based on actual bandwidth consumption and application requirements. In some embodiments, the framework can monitor per-client data rates, application types, and quality metrics to make advanced load balancing decisions that consider both current network conditions and predicted future demand. The framework can also implement predictive load balancing, pre-emptively redistributing clients before congestion occurs based on learned usage patterns.

In some embodiments, for environments with multiple access points or mesh nodes, the framework can coordinate optimization decisions across the entire network infrastructure. Such coordination can involve complex algorithms that consider the interdependencies between different optimization parameters, ensuring that improvements in one area do not negatively impact performance in other areas. In some embodiments, the framework can implement global optimization strategies that consider the entire network topology as a single optimization domain rather than treating individual nodes in isolation.

In some embodiments, the framework can also implement user-specific optimization strategies that learn individual usage patterns and preferences. In some embodiments, for households with multiple users having different network usage characteristics—such as gamers requiring low latency, remote workers needing reliable connectivity, or streaming enthusiasts demanding high bandwidth—the framework can develop personalized optimization profiles that activate based on device identification and usage context. Such profiles can encompass parameters such as preferred frequency bands, QoS priorities, and even time-of-day optimization strategies.

According to some embodiments, advanced interference mitigation within the framework can utilize machine learning techniques to identify and adapt to various types of interference sources. In some embodiments, the framework can distinguish between different interference patterns, such as microwave ovens, Bluetooth devices, neighboring Wi-Fi networks, and other electronic devices, implementing targeted mitigation strategies for each interference type. In some embodiments, the framework can also learn the temporal patterns of interference sources, enabling proactive mitigation strategies that anticipate interference events.

### Wi-Fi Motion Detection

In some embodiments, the disclosed Wi-Fi motion detection capabilities of the framework leverage the inherent properties of wireless signal propagation to create an advanced sensing system that can detect human presence and movement throughout the home environment. Such technology exploits the fact that Wi-Fi signals naturally permeate the home environment, and any movement or change in the physical environment causes measurable variations in signal characteristics that can be analyzed to infer motion and occupancy patterns.

In some embodiments, the framework can implement Channel State Information (CSI) analysis techniques that examine the multipath propagation characteristics of Wi-Fi signals. As radio waves travel from transmitter to receiver, they encounter various objects, surfaces, and obstacles that cause reflections, diffractions, and attenuations. For example, when humans move within this environment, their bodies alter the propagation paths, creating distinctive changes in the CSI that can be detected and analyzed. In some embodiments, the framework can process these CSI variations using advanced signal processing algorithms to distinguish between different types of movement and to filter out non-human sources of signal variation.

In some embodiments, the framework can utilize multiple access points or mesh nodes to create a comprehensive sensing network that provides enhanced coverage and accuracy compared to single-point sensing systems. By analyzing signal variations across multiple transmitter-receiver pairs, the framework can implement triangulation and multilateration techniques to determine not only the presence of motion but also the approximate location and direction of movement. Such multi-point analysis can significantly improve the robustness and accuracy of motion detection while reducing false positives caused by environmental factors such as moving curtains or mechanical vibrations.

In some embodiments, the signal processing within the framework can implement advanced filtering and analysis techniques to extract motion-related features from the complex Wi-Fi signal environment. In some embodiments, the framework can utilize techniques such as wavelet analysis, frequency domain processing, and statistical signal processing to identify the specific frequency components and temporal patterns that correlate with human movement. These processing techniques can enable the framework to distinguish between different types of motion, such as walking, sitting, or even breathing patterns, providing rich contextual information about occupancy and activity levels.

In some embodiments, the framework can implement AI/ML algorithms specifically trained to recognize motion patterns and to adapt to the unique characteristics of each home environment. These algorithms can learn to distinguish between legitimate motion events and environmental noise sources, such as changes in heating and air conditioning systems, appliance operations, or external factors like weather conditions. In some embodiments, the learning process can enable the framework to become increasingly accurate over time as it accumulates data about the specific environment and develops refined models for motion detection in that particular setting.

In some embodiments, the framework can correlate Wi-Fi motion detection data with other available sensor inputs to create a more comprehensive understanding of home occupancy and activity patterns. By integrating motion detection with data from smart thermostats, lighting systems, door sensors, and other IoT devices, the framework can develop a holistic view of home activity that provides context for motion events. Such sensor fusion approach can improve accuracy while enabling more advanced applications that require understanding of both motion and environmental context.

In some embodiments, the privacy protection within the Wi-Fi motion detection system can be implemented through local processing and data anonymization techniques. In some embodiments, the framework can process all motion detection data locally on home devices, ensuring that sensitive information about occupancy patterns and daily routines never leaves the home environment. In some embodiments, the framework can also implement temporal data retention policies that automatically purge detailed motion data after specified periods while retaining only aggregated patterns necessary for system optimization.

In some embodiments, the framework can implement advanced pattern recognition capabilities that learn to identify specific individuals based on their unique movement characteristics. Different people have distinctive gait patterns, movement speeds, and behavioral routines that can be recognized through Wi-Fi signal analysis. Such capability can enable personalized home automation responses, such as adjusting lighting or temperature preferences based on which family member has entered a room, while maintaining privacy by processing this information entirely within the home environment.

In some embodiments, for multi-story or complex home layouts, the framework can implement three-dimensional motion tracking that provides information about movement between floors and in vertical spaces. By analyzing signal propagation patterns and utilizing multiple access points at different elevations, the framework can track movement up and down stairs, between floors, and in areas with significant vertical components. Such capability can be particularly valuable for safety monitoring applications, especially in homes with elderly residents where fall detection may be important.

In some embodiments, the framework can also implement motion prediction capabilities that anticipate likely movement patterns based on historical data and current context. By learning daily routines and recognizing recurring patterns, the framework can predict when and where motion is likely to occur, enabling proactive automation responses. For example, the framework can predict when someone is likely to move from the bedroom to the kitchen in the morning and can pre-emptively adjust, network, power, lighting and/or temperature devices and/or settings accordingly.

### Occupancy Sensing

In some embodiments, the disclosed occupancy sensing capabilities of the framework extend beyond simple motion detection to provide comprehensive understanding of space utilization, occupant behavior patterns, and real-time occupancy status throughout the home environment. Such advanced sensing system can integrate multiple data sources and analysis techniques to develop detailed occupancy models that support advanced automation, energy management, and security applications.

In some embodiments, the framework can implement multi-modal sensing approaches that combine Wi-Fi signal analysis with data from various connected devices and sensors throughout the home. In some embodiments, the framework can correlate Wi-Fi-based motion detection with information from smart thermostats, lighting sensors, door and window sensors, smart locks, and other IoT devices to create a comprehensive picture of occupancy patterns. This sensor fusion approach can provide much higher accuracy and reliability than any single sensing modality, while also providing rich contextual information about occupancy characteristics.

In some embodiments, the framework can develop advanced occupancy classification algorithms that distinguish between different types of occupancy scenarios. In some embodiments, the framework can differentiate between active occupancy where people are moving and engaged in activities, passive occupancy where people are present but relatively stationary, and transitional occupancy where people are moving between spaces. Such classification capability can enable more nuanced automation responses that consider not just whether spaces are occupied, but how they are being used and what activities are taking place.

In some embodiments, for multi-occupant households, the framework can implement person identification and tracking capabilities that maintain awareness of individual occupants throughout the home. By analyzing unique movement patterns, device usage characteristics, and behavioral signatures, the framework can develop models that recognize different household members and track their individual movements and preferences. Such capability can enable highly personalized automation responses while maintaining privacy by processing all identification data locally within the home environment.

In some embodiments, the framework can analyze temporal occupancy patterns to learn household routines and identify recurring occupancy schedules. The framework can recognize patterns such as work schedules, sleep routines, meal times, and recreational activities, building predictive models that anticipate future occupancy states. These predictive capabilities can enable proactive automation that prepares spaces before they are occupied, such as adjusting temperature and lighting conditions in advance of predicted occupancy events.

In some embodiments, room-level occupancy resolution within the framework can provide detailed understanding of how different spaces within the home are utilized. In some embodiments, the framework can maintain occupancy status for individual rooms, tracking not only whether rooms are occupied but also occupancy duration, frequency of use, and typical activity patterns. Such granular occupancy information can support advanced energy management strategies that optimize heating, cooling, and lighting based on actual space utilization rather than simple schedules or manual controls.

In some embodiments, the framework can implement occupancy-based security features that distinguish between normal household activity and potential security events. By learning typical occupancy patterns, the framework can identify anomalous occupancy events that may indicate unauthorized entry or unusual activity. In some embodiments, the framework can correlate occupancy data with other security indicators such as door and window sensor activity, time of day, and expected household schedules to provide intelligent security monitoring that minimizes false alarms while maintaining high sensitivity to genuine security concerns.

In some embodiments, for energy management applications, the framework can provide detailed occupancy data that enables advanced demand response and energy optimization strategies. In some embodiments, the framework can identify which spaces are actively occupied and adjust HVAC systems accordingly, potentially achieving significant energy savings by avoiding heating or cooling of unoccupied spaces. In some embodiments, the framework can also optimize lighting systems based on actual occupancy, automatically adjusting brightness levels and turning lights on or off based on real-time occupancy status and learned preferences.

In some embodiments, the framework can implement occupancy analytics that provide insights into space utilization patterns and household behavior trends. In some embodiments, the framework can generate reports and visualizations showing how different spaces are used throughout the day, week, and seasonal cycles, providing valuable information for home layout optimization, energy usage analysis, and lifestyle insights. Such analytics, which can be captured as a file, object, item and/or data structure, for example, can be utilized to understand a space's utilization patterns and be leveraged for automated and/or informed decisions about home modifications or routine adjustments.

In some embodiments, privacy protection in occupancy sensing can be implemented through advanced data processing techniques that maintain functionality while protecting sensitive information. The framework can process occupancy data using differential privacy techniques, local data retention policies, and anonymization methods that prevent the reconstruction of detailed personal activity patterns while maintaining the utility of the data for automation and optimization purposes. In some embodiments, detailed occupancy data can remain within the home environment, with only aggregated and anonymized insights shared with external systems when necessary.

In some embodiments, the framework can support occupancy-based health and wellness monitoring capabilities that track general activity levels and routines without invasive monitoring. By analyzing occupancy patterns, the framework can identify changes in daily routines that can indicate health concerns, particularly for elderly household members. In some embodiments, the framework can detect variations in sleep patterns, reduced mobility, or unusual occupancy patterns that can warrant attention, while maintaining privacy by processing all health-related inferences locally.

In some embodiments, for households with specific accessibility needs, the framework can implement specialized occupancy sensing features that support assisted living scenarios. The framework can monitor occupancy patterns for signs of distress or emergency situations, such as extended periods of inactivity in areas where activity would normally be expected, or occupancy patterns that deviate significantly from established routines. These capabilities can provide peace of mind for family members while maintaining the dignity and privacy of monitored individuals.

### IoT Automation

In some embodiments, the disclosed IoT automation capabilities of the framework represent a comprehensive approach to smart home integration that can orchestrate interactions between diverse connected devices and systems throughout the home environment. Rather than relying on cloud-based automation platforms or manufacturer-specific ecosystems, the framework can implement local automation intelligence that provides faster response times, enhanced privacy protection, and greater reliability through reduced dependency on external services.

In some embodiments, the framework can implement a unified device abstraction layer that can communicate with IoT devices regardless of their underlying communication protocols or manufacturer specifications. In some embodiments, the framework can support popular protocols including Zigbee, Z-Wave, Thread, Matter, Wi-Fi, and Bluetooth, creating a protocol-agnostic automation environment that can integrate devices from multiple manufacturers into cohesive automation scenarios. This abstraction layer can eliminate the complexity typically associated with multi-protocol IoT environments while enabling advanced cross-device interactions.

In some embodiments, the framework can develop intelligent automation rules that go beyond simple conditional logic to implement context-aware automation strategies. The framework can analyze multiple data streams simultaneously, including occupancy information, environmental conditions, time-based patterns, and user behavior data, to make advanced automation decisions that consider the full context of each situation. For example, rather than simply turning on lights when motion is detected, the framework can consider factors such as time of day, ambient light levels, identified occupant preferences, and current activities to determine optimal lighting responses.

In some embodiments, AI/ML algorithms within the framework can enable automation systems to learn and adapt to household preferences and routines over time. In some embodiments, the framework can observe user interactions with automated systems, noting when manual overrides occur and what conditions led to user satisfaction or dissatisfaction with automation responses. Such learning capability can enable the framework to refine automation rules continuously, becoming more aligned with user preferences and more accurate in predicting desired responses to various situations.

In some embodiments, the framework can implement predictive automation capabilities that anticipate user needs and preferences based on learned patterns and current context. For example, in some embodiments, by analyzing historical data about user behavior, environmental conditions, and automation interactions, the framework can predict likely user needs and proactively adjust connected devices. For example, the framework can predict when users are likely to return home and can pre-condition the home environment by adjusting temperature, lighting, and security systems in advance of their arrival.

In some embodiments, for complex automation scenarios involving multiple devices and frameworks, the framework can implement orchestration capabilities that coordinate sequences of actions across different device types and protocols. In some embodiments, the framework can manage timing dependencies, handle device response delays, and implement error recovery procedures to ensure that complex automation scenarios execute reliably. Such orchestration capability can enable advanced automation workflows such as comprehensive security routines, energy management sequences, or entertainment system configurations that involve multiple interconnected devices.

In some embodiments, the framework can provide advanced scene management capabilities that can create and execute complex environmental configurations involving multiple connected devices. These scenes can encompass lighting, climate control, entertainment systems, security devices, and other connected home systems, creating comprehensive environmental states optimized for specific activities or preferences. The framework can learn which scene configurations are most appropriate for different contexts and can automatically suggest or activate scenes based on current conditions and user patterns.

In some embodiments, energy management automation within the framework can implement advanced demand response and optimization strategies that consider real-time energy prices, occupancy patterns, and device usage characteristics. In some embodiments, the framework can automatically adjust the operation of energy-consuming devices based on factors such as time-of-use electricity pricing, renewable energy generation availability, and predicted household energy needs. Such capability can enable significant energy cost savings while maintaining user comfort and convenience.

In some embodiments, the framework can implement safety and security automation features that can respond to various types of emergency or security events. In some embodiments, the framework can correlate data from smoke detectors, security sensors, cameras, and other monitoring devices to implement comprehensive emergency response procedures. For example, in the event of a security breach, the framework can automatically lock doors, activate cameras, adjust lighting to deter intruders, and send appropriate notifications to homeowners and monitoring services.

In some embodiments, for households with elderly residents or individuals with specific health monitoring needs, the framework can implement health and wellness automation features that can detect unusual patterns or potential emergency situations. In some embodiments, the framework can monitor routine patterns, medication reminders, and activity levels to identify deviations that can indicate health concerns. In some embodiments, the automation mechanisms can respond to these situations by adjusting environmental conditions, sending alerts to family members or caregivers, or activating emergency response procedures as appropriate.

In some embodiments, the framework can support voice control integration that enables natural language interaction with automation systems. In some embodiments, by processing voice commands locally using edge-based speech recognition and natural language processing (NLP), the framework can provide responsive voice control while maintaining privacy by keeping voice data within the home environment. In some embodiments, the voice control mechanisms can understand complex commands that involve multiple devices and can learn to recognize different household members'voices and preferences.

In some embodiments, automation customization within the framework can provide extensive user control over automation behavior through intuitive interfaces and configuration options. Users can define custom automation rules, adjust sensitivity levels, set time-based restrictions, and override automatic behaviors as needed. In some embodiments, the framework can provide both simple interfaces for basic automation needs and advanced configuration options for users who want detailed control over automation behavior.

In some embodiments, the framework can implement automation analytics that provide insights into home automation performance, energy usage patterns, and user interaction trends. These analytics can help users understand how their automation systems are performing, identify opportunities for optimization, and make informed decisions about automation rule adjustments. In some embodiments, the analytics can also provide feedback about the effectiveness of different automation strategies and suggest improvements based on observed patterns.

In some embodiments, integration with external services and platforms can be supported through secure API interfaces that allow the framework to interact with utility companies, security monitoring services, and other external systems while maintaining local control over automation decisions. Such capability can enable participation in demand response programs, integration with professional monitoring services, and coordination with smart grid systems while preserving the privacy and autonomy of the local automation system.

In some embodiments, the framework can support automation backup and recovery capabilities that ensure continuity of automation services even in the event of device failures or network disruptions. In some embodiments, the framework can maintain redundant automation configurations across multiple devices and can automatically failover to backup systems when primary automation controllers become unavailable. Such redundancy can ensure that critical automation functions continue to operate reliably even under adverse conditions.

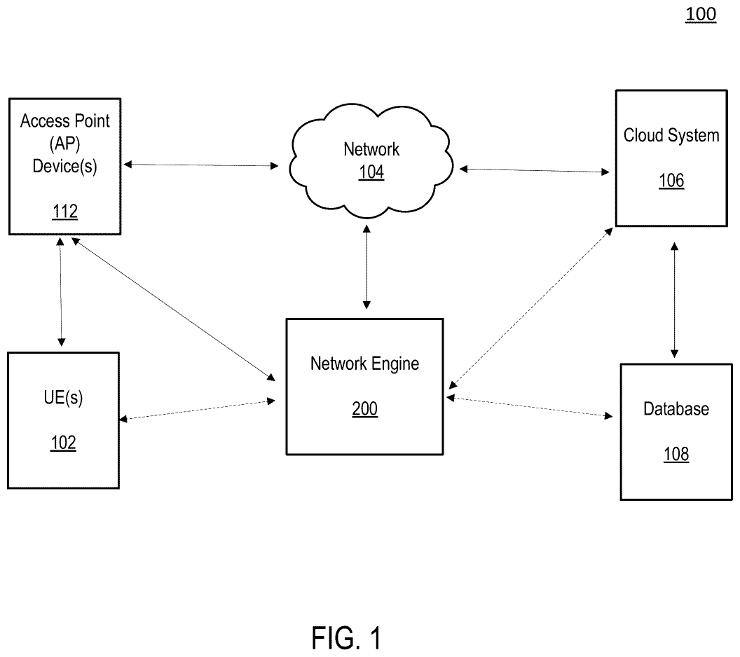

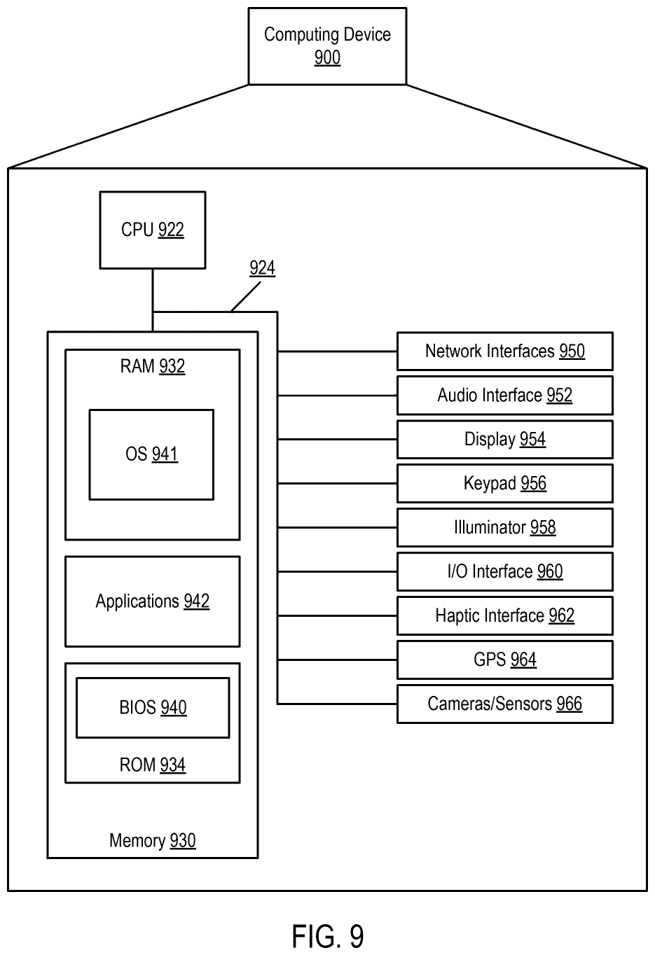

With reference to FIG. 1, system 100 is depicted which includes user equipment (UE) 102 (e.g., a client device, as mentioned above and discussed below in relation to FIG. 9), access point (AP) device 112, network 104, cloud system 106, database 108 and network engine 200. It should be understood that while system 100 is depicted as including such components, it should not be construed as limiting, as one of ordinary skill in the art would readily understand that varying numbers of UEs, AP devices, peripheral devices, sensors, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, IoT device, wearable device, autonomous machine, smart television, set top box (STB), media streaming device, game console, and any other device equipped with a cellular or wireless or wired transceiver. For example, UE 102 can be a smart phone of a user.

In some embodiments, peripheral devices (not shown) can be connected to UE 102, and can be any type of peripheral device, such as, but not limited to, a wearable device (e.g., smart ring, smart watch, for example), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

In some embodiments, UE 102 can include and/or correspond to, but not be limited to, any type of device, component and/or sensor associated with a location of system 100 (referred to, collectively, as “sensors”). In some embodiments, the UE 102 can be any type of device that is capable of sensing and capturing data/metadata related to activity of the location. In some embodiments, the sensors can be associated with devices associated with the location of system 100, such as, for example, STBs, access point devices, televisions, personal assistants (e.g., Alexa®, Nest®, for example)), smart phones, smart watches or other wearables, tablets, personal computers, and the like, and some combination thereof. In some embodiments, UE 102 can be associated with any device connected and/or operating on cloud system 106 (e.g., a cloud-based device, such as a server that collects information related to the location, for example).

According to some embodiments, AP device 112 is a device that creates and/or provides a wireless local area network (WLAN) for the location. According to some embodiments, the AP device 112 can be, but is not limited to, a router, switch, hub, gateway, extender and/or any other type of network hardware that can project a WiFi signal to a designated area. In some embodiments, UE 102 may be an AP device.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a service provider, content provider, internet service provider ISP), communication service provider (CSP), and the like, which has associated network resources hosted on the internet or private network (e.g., network 104), which enables (via engine 200) the content management and delivery discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, and the services and applications provided by cloud system 106 and/or network engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

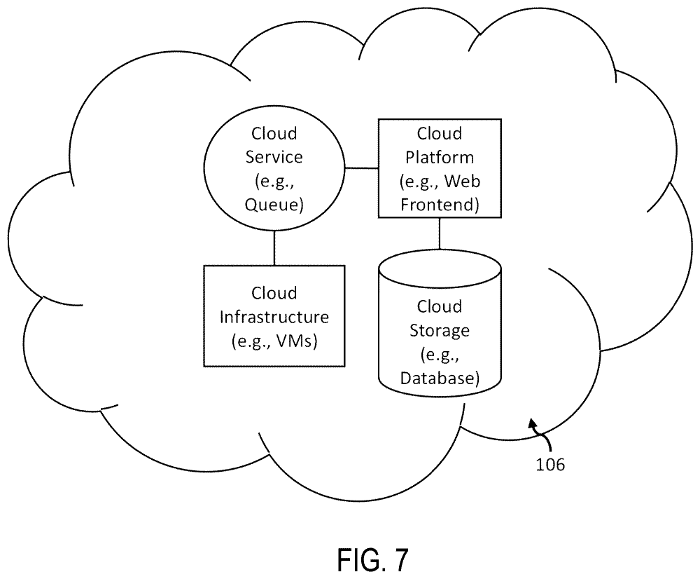

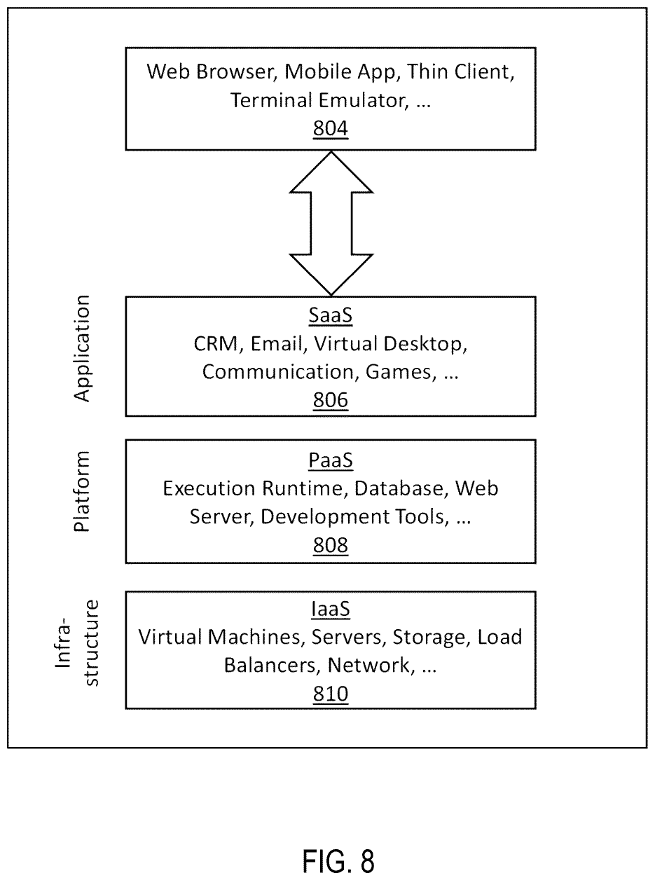

Turning to FIGS. 7 and 8, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 810, platform as a service (PaaS) 808, and/or software as a service (SaaS) 806 using a web browser, mobile app, thin client, terminal emulator or other endpoint 804. FIGS. 7 and 8 illustrate schematics of non-limiting embodiments of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, structured query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Network engine 200, as discussed above and further below in more detail, can include components for the disclosed functionality. According to some embodiments, network engine 200 may be a special purpose machine or processor, and can be hosted by a device on network 104, within cloud system 106, on AP device 112 and/or on UE 102. In some embodiments, engine 200 may be hosted by a server and/or set of servers associated with cloud system 106.

According to some embodiments, network engine 200 or other device(s) running Processes 300-600, discussed infra, can be operated entirely at the user device level (or local or local network (e.g., WiFi) level), and/or in some embodiments, with cloud support as a distributed system, or at a service provider's infrastructure, as non-limiting implementation examples. It will be understood that the disclosure herein provides for a configuration that is platform agnostic and can be operated on multiple alternative platforms as a matter of design choice using the teachings described.

According to some embodiments, as discussed in more detail below, network engine 200 may be configured to implement and/or control a plurality of services and/or microservices, where each of the plurality of services/microservices are configured to execute a plurality of workflows associated with performing the disclosed network management. Non-limiting embodiments of such workflows are discussed and provided below.

According to some embodiments, as discussed above, network engine 200 may function as an application provided by a content and/or service provider and/or cloud system 106. In some embodiments, engine 200 may function as an application installed on a server(s), network location and/or other type of network resource associated with system 106. In some embodiments, engine 200 may function as an application installed and/or executing on AP device 112 and/or UE 102. In some embodiments, such application may be a web-based application accessed by AP device 112 and/or UE 102, and/or devices accessible over network 104 from cloud system 106. In some embodiments, engine 200 may be configured and/or installed as an augmenting script, program or application (e.g., a plug-in or extension) to another application or program provided by cloud system 106 and/or executing on AP device 112 and/or UE 102. Accordingly, as provided below, engine 200 can execute on a device, at a network location, on nodes of a network and/or across a network, on differing components to perform the operations of each module executing therein.

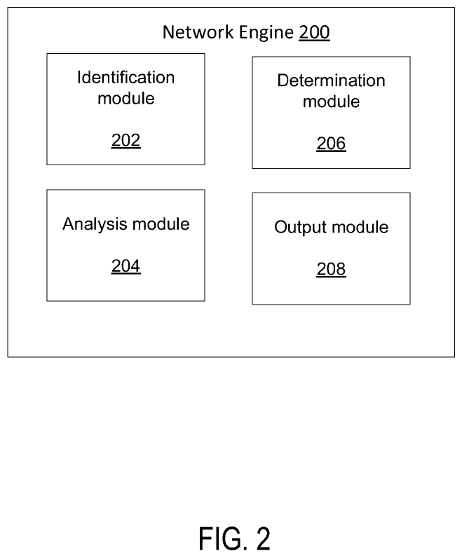

As illustrated in FIG. 2, according to some embodiments, network engine 200 includes identification module 202, analysis module 204, determination module 206 and output module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

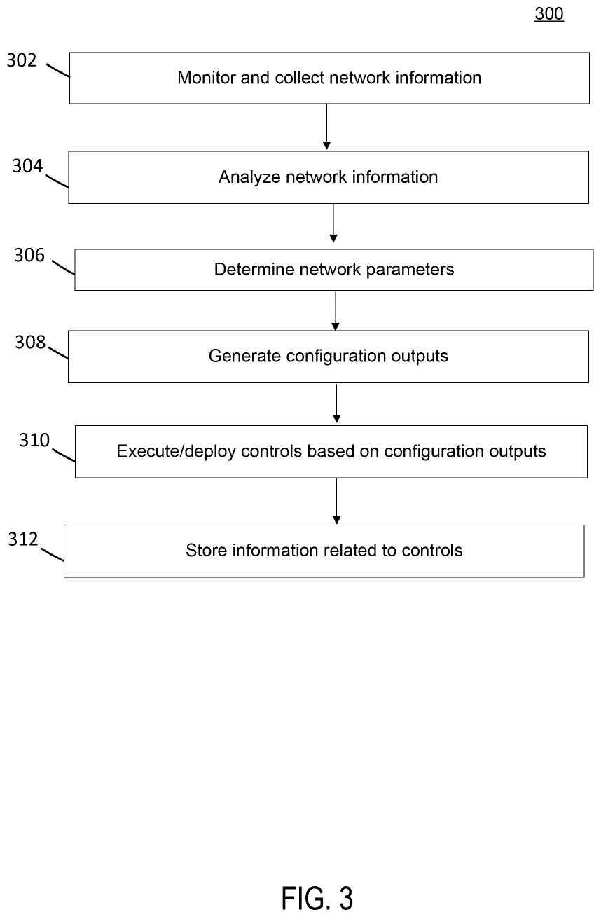

Turning to FIG. 3, Process 300 provides non-limiting example embodiments for the disclosed network management. As discussed herein, Process 300 provides operational steps for local-only processing (with optional cloud for federated learning) of AI-enhanced networking mechanisms, as discussed herein. As discussed below, according to embodiments, engine 200 implements a fully local, AI-powered Wi-Fi optimization framework that executes dynamically and autonomously within the premises of the smart home, independent of any centralized cloud control. In some embodiments, engine 200 can be embedded within a distributed edge architecture and utilizes elastic edge computing techniques to dynamically allocate processing tasks across networked home devices (e.g., access points, mesh nodes, gateways). The Wi-Fi optimization function operates cyclically and comprises six core phases, outlined below in the steps of Process 300.

According to some embodiments, Step 302 of Process 300 can be performed by identification module 202 of network engine 200; Step 304 can be performed by analysis module 204; Steps 306 can be performed by determination module 206; and Steps 308-312 can be performed by output module 208.

According to some embodiments, Process 300 begins with Step 302 where engine 200 can continuously monitor and collect a broad range of telemetry and contextual data from all devices within a smart home network, including but not limited to wireless access points, mesh nodes, client devices, and IoT endpoints. In some embodiments, engine 200 can leverage low-level radio drivers and kernel interfaces to extract physical layer (PHY) metrics such as Received Signal Strength Indicator (RSSI), Signal-to-Noise Ratio (SNR), modulation and coding scheme (MCS) values, channel utilization histograms, and PHY data rate distributions. These measurements can be sampled at sub-second intervals and timestamped with high-resolution system clocks to support accurate temporal modeling. In some embodiments, engine 200 can also collect medium access control (MAC) layer statistics, including retry counts, beacon loss, association request/rejection logs, and frame error rates. Additional telemetry may include device-level logs related to CPU and memory load, queue depths, and packet processing latency to assist in correlating application-level performance with underlying hardware constraints.

In some embodiments, in parallel, engine 200 can gather client-specific association data, such as Basic Service Set Identifier (BSSID) mapping, band preferences (2.4 GHz, 5 GHz, 6 GHz), roaming frequency, session duration, and dwell time at each access point. Client metadata, such as Organizationally Unique Identifier (OUI)-derived manufacturer information and DHCP-assigned hostnames, can be cross-referenced against an evolving device classification model to determine device roles (e.g., smart TV, gaming console, smartphone). Environmental conditions, such as transient interference and persistent noise sources, can be identified through passive spectrum sensing. In some embodiments, engine 200 can employ real-time Fast Fourier Transform (FFT) analysis on sampled I/Q data to detect non-Wi-Fi signals and spectral anomalies. In addition, engine 200 can ingest application-level traffic features through deep packet inspection (where permitted) or traffic shape heuristics, including throughput, latency, jitter, burst length, inter-arrival times, and transport-layer protocol signatures.

In Step 304, engine 200 can analyze the aggregated telemetry using a layered AI/ML processing pipeline operating entirely within the local edge infrastructure. Data preprocessing can include normalization, filtering of outliers, and temporal smoothing using moving average or exponential decay kernels. In some embodiments, engine 200 can employ convolutional and recurrent neural network architectures to identify complex temporal and spatial correlations across the telemetry streams. For example, long short-term memory (LSTM) networks can model time-varying behaviors of individual clients to forecast bandwidth demand or roaming events, while graph-based convolutional networks (GCNs) can model spatial relationships between access points and their overlapping coverage areas.

In some embodiments, unsupervised learning methods such as Principal Component Analysis (PCA), Autoencoders, and clustering algorithms (e.g., Density-Based Spatial Clustering of Applications with Noise (DBSCAN), Gaussian Mixture Models, for example) can be used to identify latent structure in the data, including anomaly detection (e.g., rogue AP behavior or abnormal usage spikes) and segmentation of client behavior into usage personas. In some embodiments, engine 200 can also incorporate reinforcement learning agents (e.g., Direct reference Optimization (DPO), Proximal Policy Optimization (PPO) algorithms, and the like) trained on simulated or historical real-world data to explore optimal policy actions with respect to channel selection, client steering, and airtime management. Each AI model can be trained incrementally using online learning, adapting to the unique and evolving conditions of each household network.

Accordingly, as discussed herein, such analysis can involve engine 200 implementing any type of known or to be known computational analysis technique, algorithm, mechanism or technology. In some embodiments, engine 200 may include a specific trained AI/ML model, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may leverage an LLM(s), whether known or to be known. As discussed herein, an LLM is a type of AI system designed to understand and generate human-like text based on the input it receives. The LLM can implement technology that involves deep learning, training data and natural language processing (NLP). Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. Such includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, engine 200 may be configured to utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the data, as discussed herein.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 306, engine 200 can determine an optimal set of configuration parameters and operational policies based on the insights extracted during the analysis phase. These determinations are context-specific and continuously updated. For band and channel assignment, engine 200 can compute optimal configurations that minimize co-channel and adjacent-channel interference, maximize spectral efficiency, and avoid DFS (Dynamic Frequency Selection)-sensitive bands when latency is critical. For example, engine 200 may determine that a particular client should be pinned to the 5 GHz band during evening hours due to high interference in the 2.4 GHz band caused by microwave usage, which is temporally correlated in the analysis.

For mesh topologies, engine 200 can compute optimal backhaul routing configurations using metrics such as Expected Transmission Count (ETX), per-hop latency, and available link bandwidth. In some embodiments, engine 200 can dynamically assign root nodes and adjust forwarding tables in response to environmental changes such as node failure or signal obstruction. In some embodiments, engine 200 can also determine dynamic QoS and/or QoE priorities using multidimensional application classification. For example, engine 200 may assign high-priority service levels to low-latency flows like video conferencing while deprioritizing bulk traffic such as OS updates. Device mobility patterns, usage density, and expected future demand can further inform predictive decisions to avoid congestion before it manifests.

In Step 308, engine 200 can generate concrete configuration outputs, expressed as structured control commands or policy objects. These outputs can be compiled into low-level device instructions via standard and vendor-specific interfaces. For example, engine 200 can translate high-level optimization directives into TR-181 data model updates and dispatch them via TR-069 or TR-369 (USP) protocol sessions to appropriate network devices. In OpenSync-compatible environments, JSON-based policy trees can be pushed to the Access Point Manager (APM) module. In some embodiments, engine 200 can also utilize, for example, Netlink sockets, gRPC APIs, or command-line interface (CLI) wrappers for platforms that expose programmatic control endpoints.

In some embodiments, such generated control data can include, but is not limited to, updated radio configurations (e.g., transmit power, antenna gain, channel bandwidth), client steering rules (e.g., BSS transition management frames with RSSI thresholds), and DSCP markings for upstream traffic classification. In some embodiments, engine 200 can generate firmware-level scheduler hints, queue management policies (e.g., Weighted Fair Queueing parameters), and airtime allocation vectors for fair usage enforcement. These outputs are generated with dependency graphs to account for interaction effects, such that one change (e.g., increasing power on AP1) does not inadvertently cause a degradation elsewhere (e.g., increased interference with AP2).

In Step 310, engine 200 can execute the deployment of the generated control policies through its orchestration subsystem. This can involve atomic application of configuration deltas using transactional update mechanisms. In some embodiments, devices can receive configuration payloads over encrypted local management channels using, for example, Transport Layer (TLS)-secured Remote Procedure Call (RPC) or Message Queuing Telemetry Transport (MQTT) messaging protocols. In some embodiments, engine 200 can sequence updates to minimize user disruption; for example, by scheduling channel reassignments during low-activity windows or leveraging 802.11k/v-assisted roaming to preemptively inform clients of imminent changes. The orchestration layer can use commit-verify-rollback semantics, allowing configurations to be automatically reverted if degradation in KPIs (Key Performance Indicators) such as throughput or packet loss exceeds predefined thresholds.

In some embodiments, engine 200 can also manage synchronization across multiple nodes, ensuring that mesh topology updates, band steering policies, and load balancing heuristics are coordinated across the network fabric. During this phase, engine 200 can continue passive telemetry capture to measure the immediate and long-term impact of its optimizations, including metrics like throughput deltas, client satisfaction indices (e.g., estimated MOS for VoIP), and spectral efficiency. Feedback signals can be routed into the analysis layer to validate model assumptions and retrain decision policies, closing the optimization loop.

In Step 312, engine 200 can persistently store both the raw input telemetry and the derived optimization artifacts, including model parameters, inference outcomes, configuration deltas, and performance feedback. Such data can be structured using a version-controlled local database, such as SQLite or a lightweight time-series database such as, for example InfluxDB, with encryption at rest and integrity checks. Metadata such as model training epochs, hyperparameters, and validation metrics are also archived to support reproducibility and long-term system evolution.

In some embodiments, engine 200 can support an optional federated learning interface, wherein local models periodically export anonymized parameter updates to a centralized aggregation node (e.g., a cloud service operated by the network provider). In some embodiments, no raw telemetry or personally identifiable information is transmitted. Instead, engine 200 can serialize compressed weight deltas or gradient updates using formats such as, for example, Protocol Buffers or FlatBuffers, and transmit them asynchronously using gRPC or RESTful APIs. This federated approach enables global model refinement, seeding new installations with high-quality priors while preserving data sovereignty and minimizing cloud operating costs.

Accordingly, Steps 302-312 of Process 300 provide functionality to engine 200 to perform closed-loop, context-aware Wi-Fi optimization entirely within the home environment. The framework dynamically adapts to evolving conditions using real-time monitoring, distributed inference, and coordinated control execution, all anchored in a privacy-preserving, elastic edge computing architecture. Such capabilities offer a significant advancement over traditional, rule-based Wi-Fi management systems by providing personalized, anticipatory, and continuously improving network performance without requiring direct user intervention or cloud dependency.

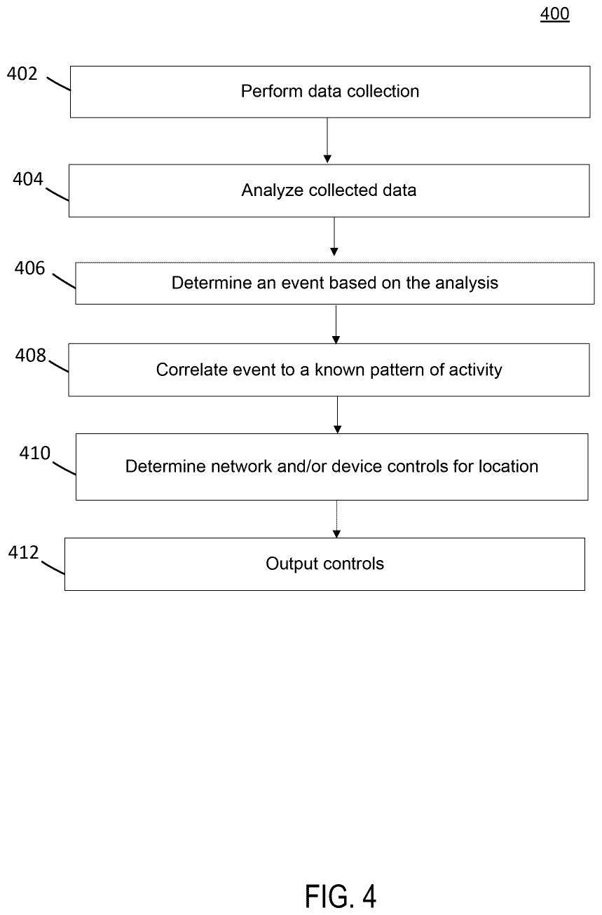

Turning to FIG. 4, provided is Process 400 for non-limiting example embodiments for Wi-Fi motion detection operations and/or mechanisms, as discussed herein. According to some embodiments, Step 402 of Process 400 can be performed by identification module 202 of network engine 200; Steps 404 and 408 can be performed by analysis module 204; Steps 406 and 410 can be performed by determination module 206; and Step 412 can be performed by output module 208.

According to some embodiments, Process 400 begins with Step 402 where engine 200 can initiate data collection by gathering raw Wi-Fi signal information from various nodes within the smart home network. In some embodiments, engine 200 can retrieve fine-grained signal characteristics such as Channel State Information (CSI), Received Signal Strength Indicator (RSSI), and Time of Flight (ToF) metrics from one or more access points or mesh nodes deployed throughout the premises. In some embodiments, such metrics provide detailed insights into how wireless signals propagate through the physical environment at a given moment. In embodiments where the smart home network comprises a mesh topology, engine 200 can collect these signal characteristics from multiple transmitter-receiver pairs operating on different channels and bands (e.g., 2.4 GHz and 5 GHz). Such multidimensional dataset serves as the foundational input from which signal anomalies—caused by physical motion, changes in obstructions, or dynamic environmental conditions—can be detected and interpreted. In some embodiments, engine 200 can synchronize the data collection process across all nodes to maintain temporal alignment, allowing the framework to accurately correlate signal disturbances across spatially distributed points. The framework may also apply initial pre-filtering at the edge node or device level to reduce the volume of non-informative or redundant data before forwarding the relevant packets for further analysis.

In Step 404, engine 200 can analyze the collected signal data using a combination of advanced digital signal processing (DSP) and AI/ML techniques to extract motion-relevant features. According to some embodiments, such analysis can be performed via the AI/ML techniques discussed above.

In some embodiments, Step 404's analysis can begin with identifying temporal and spectral characteristics of the incoming signals that deviate from baseline conditions, which represent a static or steady-state environment. For example, CSI matrices can be decomposed using principal component analysis (PCA) or singular value decomposition (SVD) to identify the dominant signal paths and fluctuations indicative of physical movement. In some embodiments, engine 200 can apply time-frequency transforms such as the Short-Time Fourier Transform (STFT) or continuous wavelet transform (CWT) to capture transient patterns associated with dynamic motion events. Additionally, engine 200 can compute statistical descriptors (e.g., variance, kurtosis, entropy) over sliding time windows to detect non-stationary changes that signify the presence or onset of motion. When integrated with prior data, these techniques enable engine 200 to build temporal profiles that represent the evolution of signal disturbances. Furthermore, machine learning classifiers—such as support vector machines (SVMs), convolutional neural networks (CNNs), or recurrent neural networks (RNNs)—can be employed to categorize detected patterns as human versus non-human motion, further refining the signal interpretation pipeline. Noise suppression algorithms may also be invoked to eliminate false positives arising from environmental artifacts such as HVAC activity or oscillating fans.

In Step 406, engine 200 can determine that a motion event has occurred based on the outcome of the analysis phase. Such determination can involve, but is not limited to, identifying a statistically significant deviation in signal features that correspond to known or expected signatures of movement. In some embodiments, engine 200 uses a dynamic thresholding technique that adapts to ambient environmental changes to decide whether a transient signal deviation constitutes a valid motion event. Alternatively, engine 200 can maintain a probabilistic model (e.g., Hidden Markov Model or Gaussian Mixture Model) that captures the temporal dependencies of motion-related features, and declare an event when the model's likelihood crosses a predefined confidence interval. Events can be classified according to motion granularity—such as localized movement (e.g., arm motion within a room), gross locomotion (e.g., walking from one room to another), or complex patterns like ascending stairs. In environments with multiple residents or pets, engine 200 can apply disambiguation routines that differentiate between overlapping or concurrent movement events. Event detection may also incorporate time-of-day or historical occupancy data to contextualize the movement as expected or anomalous, which can later influence automation strategies or trigger security alerts.

In Step 408, engine 200 can correlate the detected event to known patterns of activity by leveraging a historical database of previously observed motion signatures and contextual metadata. This step is critical in transforming raw motion detections into semantically meaningful activity labels, such as “resident entering the kitchen,” “sleep onset,” or “morning routine.” To facilitate this, engine 200 can employ a trained activity recognition model that maps spatiotemporal signal signatures to labeled activity classes. The model may utilize contextual input such as room location, signal propagation direction, and frequency characteristics, along with corroborating data from other smart home devices (e.g., lights turning on, temperature changes, or door openings). Pattern correlation may further involve temporal sequence matching using dynamic time warping (DTW) or sequence-to-sequence models to align the current motion signature with historically labeled activity episodes. In some embodiments, the framework may implement a hierarchical classification scheme that first categorizes the event by type (e.g., locomotion, stationary presence, fine movement) and subsequently refines the classification based on location, time of day, and recent history. Over time, in some embodiments, engine 200 can refine its pattern library by incorporating user feedback, behavior reinforcement signals, or through periodic retraining with labeled datasets, allowing it to adapt to evolving routines or occupancy patterns. This step also enables predictive reasoning—for example, anticipating a subsequent event based on historical routines—allowing the framework to proactively prepare downstream automation responses.

In Step 410, engine 200 can determine appropriate network and/or device control actions based on the classified activity pattern and the location of the event. This determination involves translating the semantic activity insight into a set of actionable system-level commands that can be issued to networked devices or services. For example, if the detected activity is classified as a person entering a room during evening hours, engine 200 can resolve to adjust smart lighting levels, prioritize low-latency network traffic for video streaming, and pre-condition the HVAC system for comfort. The determination process takes into account a set of user-defined preferences, contextual constraints (e.g., current energy load, device availability), and safety rules to ensure that control actions are both efficient and non-intrusive. In some embodiments, a decision tree or policy graph is used to map activity types to a prioritized list of control actions. More advanced embodiments may incorporate reinforcement learning agents that continuously optimize control decisions based on feedback such as user satisfaction, energy consumption, or system performance metrics. When multiple control options are available, engine 200 can evaluate cost functions or utility scores associated with each alternative, selecting the one that maximizes desired outcomes while minimizing resource usage. For security-sensitive applications, such as detecting unauthorized motion during restricted hours, the control logic may trigger alarms, lock doors, or activate video recording systems based on the location and nature of the event.

In Step 412, engine 200 can output control signals to the relevant networked components and smart devices in order to execute the determined actions. These outputs are typically transmitted via standardized communication protocols such as MQTT, Zigbee, Z-Wave, or proprietary Wi-Fi APIs, depending on the device ecosystem. In some embodiments, engine 200 can interface with a local smart home hub, edge gateway, or directly with IP-addressable endpoints to deliver these control messages. In certain configurations, control outputs may be scheduled for delayed execution or coordinated across multiple devices to ensure synchronized behaviors—such as gradually dimming lights while adjusting audio levels in a home theater setup. The output phase also includes confirmation and feedback mechanisms, where engine 200 receives acknowledgment signals from the target devices to verify successful execution. If any device fails to respond or reports a fault, engine 200 can initiate fallback procedures, such as retrying commands, escalating to alternate devices, or notifying the user. In systems that incorporate local processing and privacy-preserving architectures, these control signals are constrained to the local network, ensuring that no sensitive occupancy data is transmitted to external servers. Additionally, output controls may be logged for future auditing, diagnostics, or analytics purposes, enabling retrospective analysis of system performance and user behavior. In some embodiments, output signals may be augmented with real-time annotations that explain the rationale behind each control decision, providing transparency and user trust in automated decision-making.

Accordingly, by executing the steps outlined in Process 400, discussed supra, engine 200 enables a robust, privacy-preserving, and intelligent control framework that leverages passive sensing techniques via Wi-Fi signals to infer motion, classify activity, and orchestrate responsive actions across a smart home environment. The integration of advanced signal processing, AI/ML inference, contextual reasoning, and device actuation in a closed-loop architecture allows engine 200 to dynamically adapt to the specific spatial, temporal, and behavioral nuances of each deployment, delivering tailored automation outcomes while preserving user privacy and optimizing resource efficiency.

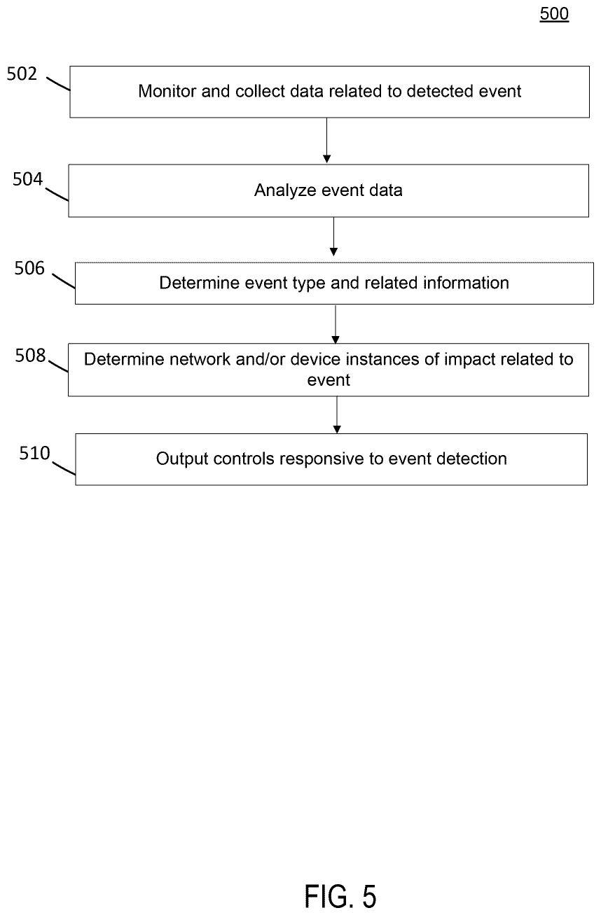

Turning to FIG. 5, provided is Process 400 for non-limiting example embodiments for occupancy sensing operations and/or mechanisms, as discussed herein. According to some embodiments, Step 502 of Process 500 can be performed by identification module 202 of network engine 200; Step 504 can be performed by analysis module 204; Steps 506 and 508 can be performed by determination module 206; and Step 510 can be performed by output module 208.

According to some embodiments, Process 500 begins with Step 502, where engine 200 can continuously monitor specific locations within the smart home environment and collect data relevant to detected events. This monitoring is not limited to basic motion detection but involves the aggregation of high-resolution, multi-modal data streams to support real-time contextual interpretation of occupancy and behavioral events. In some embodiments, engine 200 may utilize radio frequency (RF) sensing—specifically leveraging Wi-Fi Channel State Information (CSI)—as a passive means to detect the presence, movement, and relative positioning of occupants. This data may be enhanced with input from other smart home systems, including but not limited to smart thermostats (providing temperature and proximity data), smart locks and door sensors (indicating ingress or egress), lighting systems (revealing manual or automated interactions), and environmental sensors (monitoring humidity, air quality, or sound levels). For a detected event, such as a sudden change in signal variance or an abrupt door opening in a typically inactive part of the home, engine 200 can initiate a targeted data capture operation. This operation can involve polling additional sensors or increasing the sampling resolution of RF data to obtain granular temporal and spatial characteristics of the event. Furthermore, this step may involve annotating collected data with contextual metadata such as time of day, geolocation within the home, device proximity profiles, and current home mode (e.g., home, away, sleep), which are later essential for accurate event classification and control determination.

In Step 504, engine 200 can analyze the event data through a pipeline of processing operations that includes noise reduction, feature extraction, and pattern classification. In some embodiments, the analysis can begin by isolating signal anomalies or multi-sensor readings that correspond to the detected event. These anomalies may manifest as abrupt shifts in Wi-Fi phase, amplitude, or propagation delay, or as unexpected interactions with smart devices. In some embodiments, engine 200 applies preprocessing filters to reduce environmental artifacts and non-informative fluctuations—such as those caused by HVAC systems or minor structural vibrations—before extracting meaningful features. Feature vectors may include metrics such as signal power variance, Doppler profiles, temporal occupancy gradients, sensor activation timings, and zone transition rates. Advanced signal processing algorithms such as wavelet decomposition, independent component analysis (ICA), and spatiotemporal clustering may be employed to reveal latent structure within the data.

In some embodiments, engine 200 can run trained machine learning models—such as long short-term memory (LSTM) networks or transformer-based architectures—that recognize complex temporal dependencies and classify the event with high accuracy. For example, such models may distinguish between a fall, a rapid room-to-room transition, or the prolonged stationary presence of a resident in a high-risk location (e.g., bathroom or kitchen). The analysis output includes both an event classification (e.g., passive occupancy, abrupt motion, emergency-like event) and a confidence score, which influence downstream control logic.

Accordingly, as discussed above, such analysis can involve any of the AI/ML techniques discussed supra.

In Step 506, engine 200 can determine the specific type of event and extract associated information about the occupants involved. Such process synthesizes classification results from the analytical step with stored behavioral models and user identity profiles. Each occupant within a location, for example, may have a unique movement signature based on gait, habitual patterns, device usage routines, and response tendencies. In some embodiments, engine 200 can compare the current event data with previously logged patterns associated with known individuals to assign identity labels or probability-weighted identities to the detected actors. For example, if the framework detects an event characterized by slow, methodical movement patterns that match those historically associated with an elderly resident, it may classify the event as passive monitoring of a high-priority occupant. Conversely, if the motion pattern indicates erratic movement with overlapping sensor activations inconsistent with any known user, engine 200 may flag the event as anomalous, possibly indicating an unauthorized intrusion. In some embodiments, the determination of event type also incorporates environmental and temporal context—for example, movement in a child's room at night might be classified as routine if consistent with historical sleep patterns, or as concerning if occurring at an unusual hour and inconsistent with the child's typical movement behavior. In some embodiments, engine 200 may also perform correlation with calendar data, external stimuli (such as weather conditions or public holidays), and inter-device communication logs to contextualize the activity. In some embodiments, the output of this step includes a structured event profile encompassing event type, likely participants, inferred intent or urgency, and relevant environmental tags, which can be used to guide responsive control actions.

In Step 508, engine 200 can evaluate the impact of the detected and classified event on the smart home network and its connected devices, determining which entities should be controlled or modified in response. In some embodiments, Step 508 can involve a mapping process that links the semantic meaning of an event to a predefined or dynamically computed set of control operations distributed across one or more subsystems. For example, the classification of an occupant entering a bedroom during a nighttime schedule might trigger lighting adjustments, HVAC changes, and temporary muting of alert notifications.

In some embodiments, if the event is a detected fall or prolonged inactivity in a critical area, engine 200 may identify impacted devices such as voice assistants, intercom systems, or emergency lighting modules, and engage them according to a predetermined response hierarchy. Additionally, network behavior may be dynamically adjusted: QoS priorities might shift to favor streaming or conferencing traffic if the event indicates active occupancy, while non-critical background processes may be throttled to preserve bandwidth. In some embodiments, engine 200 can evaluate this in real-time, taking into account the current operational status of each device, energy availability, user-set preferences, and systemic constraints (e.g., scheduled device downtimes or maintenance). In some embodiments, engine 200 may also initiate inter-device negotiations, wherein affected devices coordinate state changes to ensure synchronized transitions, such as gradually ramping up lighting while starting a white noise generator for a sleep routine. In network-aware deployments, engine 200 can route control signals over optimized paths—e.g., selecting low-latency mesh hops or channel-hopping to reduce interference—for rapid and reliable execution. In some embodiments, the instant step culminates in the generation of a prioritized control list, with each target device or subsystem assigned a control vector that defines the nature, timing, and dependencies of the required adjustments.

In Step 510, engine 200 can output control signals to execute the determined responses across the network and device ecosystem. These control signals are transmitted via secure and standardized communication interfaces, such as MQTT for lightweight messaging, HTTPS for cloud-synchronized actions, or direct IP/UDP-based protocols for latency-sensitive operations. In some embodiments, engine 200 encapsulates control logic into structured payloads that specify not only the target state (e.g., light dim level, temperature setpoint, speaker volume) but also execution parameters such as ramp rates, delay tolerances, and conditionals (e.g., “only if room remains occupied for >3 minutes”). In embodiments emphasizing local autonomy, these commands are dispatched directly to in-home devices via edge computing nodes or mesh hubs, ensuring that no sensitive behavioral data is exposed to external networks. In some configurations, particularly those supporting hybrid cloud-local architectures, anonymized summaries of the event and control rationale may be relayed to external services for auditability or reinforcement learning purposes. In some embodiments, engine 200 also listens for acknowledgment signals from devices to confirm successful execution, logging each transaction for future diagnostics or feedback-based refinement. In the event of a failed execution—such as a nonresponsive HVAC unit—engine 200 may initiate a redundancy plan by redirecting control efforts to alternate devices (e.g., activating ceiling fans instead of central cooling) or notifying the user for manual intervention. In some embodiments, the output layer includes a human-readable log or dashboard update, providing transparency into the framework's decision-making rationale and allowing the user to override, modify, or accept the framework's response. Additionally, in some embodiments, engine 200 can append the outcome of each control action to its behavioral models, refining its future event-response mappings through reinforcement techniques or supervised learning updates. By completing this loop, framework ensures not only immediate environmental adaptation to detected events but also the ongoing evolution of the smart home's intelligence and responsiveness.

Accordingly, the steps of Process 500 enable engine 200 to perform continuous, context-aware interpretation of real-time occupancy-related events and translate these insights into highly targeted, multi-device control strategies. By integrating passive sensing, multi-modal analysis, individualized behavioral modeling, and adaptive control logic, engine 200 provides a foundation for intelligent home environments that dynamically adapt to occupant behavior and intent. The framework supports a diverse range of applications—from energy optimization and personalized comfort to anomaly detection and assistive living support—while maintaining robust privacy protections through local data processing, minimal external communication, and anonymization techniques. The flexibility and modularity of Process 500 also allow it to scale across different home configurations, occupant profiles, and automation preferences, ensuring broad applicability in next-generation smart home ecosystems.

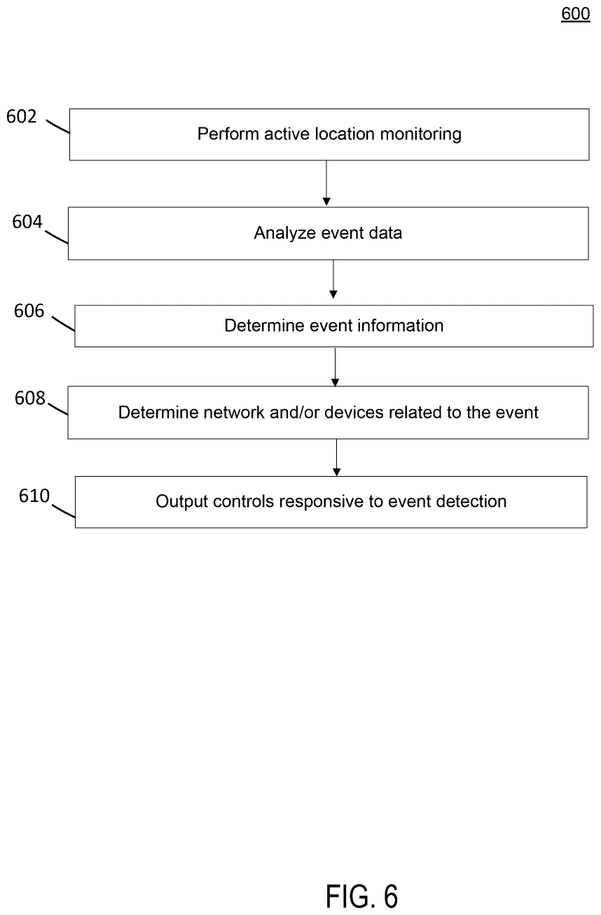

Turning to FIG. 6, provided is Process 400 for non-limiting example embodiments for IoT operations and/or mechanisms, as discussed herein. According to some embodiments, Step 602 of Process 600 can be performed by identification module 202 of network engine 200; Step 604 can be performed by analysis module 204; Steps 606 and 608 can be performed by determination module 206; and Step 610 can be performed by output module 208.

In Step 602, engine 200 can initiate active location monitoring and event-based data collection processes designed to support automation across heterogeneous IoT systems. This step involves the real-time acquisition of multi-layered environmental, behavioral, and system-state data from both internal sensors and external device interfaces. In some embodiments, engine 200 operates as an intelligent event detector by continuously evaluating contextual signals such as occupancy status derived from Wi-Fi CSI streams, ambient light levels from smart luminaires, temperature data from thermostats, door and window state data from security sensors, and even sound or vibration signatures captured by acoustic or inertial devices. Upon detecting an anomaly or significant variation from baseline—such as a door opening during expected absence hours or an unusual thermal shift in a climate-controlled zone—engine 200 engages in high-resolution data capture, directing its internal subsystems to aggregate temporally aligned data from all relevant endpoints. This includes metadata from communication protocols (e.g., Zigbee message payloads, Z-Wave command classes, or Matter device states) and external system APIs where applicable. Importantly, engine 200 also maintains event context tags such as time, location, device IDs involved, and whether the event was directly user-initiated (e.g., via voice command) or passively detected. This context-aware capture mechanism ensures that subsequent automation logic is driven by a comprehensive, situationally rich data substrate rather than isolated triggers.

In Step 604, engine 200 can perform in-depth analysis of the collected event data to extract meaningful insights, infer event intent, and construct semantic representations for downstream decision-making. In some embodiments, such analytical phase begins with signal disambiguation routines that filter out noise or overlapping signal sources—such as distinguishing between coincidental device behavior (e.g., HVAC cycle) and purposeful user-initiated activity (e.g., window opened to cool room). Signal fusion models integrate multiple data points to create unified state representations: for example, combining room occupancy certainty, ambient light flux, and recent user command history into a weighted confidence vector for scene classification. In some embodiments, engine 200 can utilize a combination of rule-based heuristics and machine-learned inference models to interpret the event; this may include decision trees for low-latency decisions, probabilistic graphical models (e.g., Bayesian Networks) for uncertainty handling, or transformer-based deep learning models trained on temporal device interaction sequences. For example, a detected door opening followed by light activation and temperature drop may be interpreted as “user entering room and requesting climate adjustment.” In more advanced deployments, engine 200 supports anomaly detection through unsupervised learning techniques, flagging rare patterns for security scrutiny or user review. In some embodiments, engine 200 can also evaluate user override behavior—e.g., if an automation was manually reversed—and uses it to score satisfaction or error likelihood, influencing both analytics and future response tuning.

Accordingly, as discussed above, such analysis can involve any of the AI/ML techniques discussed supra.

In Step 606, engine 200 can determine the specific type of event and extract additional contextual information relevant to affected individuals and devices. In some embodiments, the can involve classification of the event using a taxonomy of predefined and dynamically learned event types, including but not limited to: occupancy transitions (arrival, departure, room change), environmental threshold crossings (temperature too high or low), security-related activities (window breach, unexpected motion), and behavioral intent events (preparing for sleep, cooking, leaving for work), and the like. Each type may include associated subtypes that map onto user-defined or learned behavioral categories. In some embodiments, engine 200 associates the event with the most likely initiating agent(s)—such as a known user, guest, child, or unidentified source—based on signal signatures, device interaction patterns, and historical usage. In some embodiments, identity inference may use behavioral biometrics (e.g., walking patterns from motion paths), recent device usage fingerprints, or voice recognition results when available. Once the actor is inferred, engine 200 integrates their preferences and restrictions—such as temperature tolerances, lighting sensitivity, security clearance, or accessibility requirements—into the semantic representation of the event. In some embodiments, the instant step enables personalization of automation responses while enforcing constraints, such as parental controls or safety thresholds for vulnerable individuals. Additionally, this layer supports behavior-aware automation; for example, engine 200 can distinguish “user went to kitchen to cook” from “user entered kitchen to clean,” based on object activations (e.g., stove vs. dishwasher) and interaction timing, enabling more nuanced automation decisions.

In Step 608, engine 200 can determine which devices and networked systems are logically or functionally impacted by the classified event, as well as the corresponding control directives appropriate to that impact. In some embodiments, this involves evaluation of device states, spatial topologies, and protocol dependencies within the local IoT ecosystem. In some embodiments, engine 200 maintains a graph-based automation topology, wherein nodes represent devices, sensors, or subsystems, and edges encode functional dependencies (e.g., lighting follows occupancy, climate responds to scene type). Upon receiving the semantic event object, engine 200 queries this graph to identify both directly affected nodes (e.g., lights in a room where user entered) and indirectly affected systems (e.g., HVAC optimization zones, security system arming state). For each candidate device, engine 200 evaluates operational readiness (e.g., is device online? does it accept commands at this moment?), contextual relevance (e.g., should this light respond during the day?), and user-defined constraints (e.g., avoid turning on lights in a sleeping child's room). Based on this evaluation, engine 200 constructs a device control plan, which may include explicit commands, state transitions, or orchestration cues. For example, a “user preparing for sleep” event might trigger a cascade: reduce lighting, adjust thermostat, lock exterior doors, activate sleep tracking mode, and silence non-critical notifications. Or, in the case of an emergency event (e.g., smoke detection with active occupancy), engine 200 may identify all egress-path lighting systems, emergency intercoms, and external alert interfaces as impacted devices requiring immediate coordinated control. In some embodiments, the instant step also includes dependency conflict resolution—for example, if two events require contradictory actions for the same device, engine 200 uses priority arbitration rules or fallback hierarchies to determine the dominant action.

In Step 610, engine 200 can output control signals to the selected network and device endpoints to enact the determined automation responses. In some embodiments, such signals are formatted according to the respective protocols of the target devices, leveraging the framework's unified device abstraction layer to translate high-level intents into low-level commands across Zigbee, Z-Wave, Matter, Thread, Wi-Fi, or Bluetooth interfaces. In some embodiments, output mechanism includes both synchronous and asynchronous control strategies: immediate real-time actions (e.g., locking a door) are dispatched with high-priority flags, while time-coordinated or latency-tolerant actions (e.g., dimming lights gradually) are scheduled via event queues. In some embodiments, engine 200 also manages feedback loops by awaiting acknowledgments from devices, updating internal state caches, and, if necessary, reissuing commands or escalating via alternative control paths. In some embodiments, for complex orchestrations—such as security scenes or entertainment setups—engine 200 can use time-based triggers, dependency monitors, or conditional expressions to ensure devices enter the intended state reliably and in proper sequence. For example, before starting a projector, the framework may verify blinds are closed and ambient light levels are within range. In some embodiments, engine 200 also supports fallback behaviors: if a preferred device fails, alternate strategies (e.g., using secondary lighting or backup communication routes) are invoked to preserve functionality. All actions are logged with contextual metadata (time, source event, outcome status) for auditability, learning refinement, and user transparency. In some embodiments, where user interaction is permitted or expected, control actions may be presented via GUI notifications, natural language voice summaries, or mobile device alerts, allowing for override or confirmation. In some embodiments, in privacy-focused deployments, control signals and associated context are retained entirely on local nodes, avoiding cloud exposure; alternatively, anonymized summaries may be shared with cloud services for analytics or optimization under user-approved policies.

Accordingly, as discussed above in relation to each step of Process 600, engine 200 executes functionality and capabilities that delivers an integrated, highly responsive automation engine capable of interpreting context-rich events and translating them into intelligent, coordinated control operations across heterogeneous IoT environments. Unlike traditional rule-based systems limited to simple triggers, the disclosed framework employs multi-modal sensing, semantic reasoning, device orchestration, and adaptive control planning to produce automation outcomes that are both highly personalized and operationally robust. The local-first architecture, combined with protocol abstraction and continuous learning, enables the framework to respond dynamically to changing household needs, minimize latency, and preserve user privacy. Whether optimizing energy use, enhancing comfort, enabling assisted living, or supporting security, engine 200 leverages Process 600 to provide autonomous, contextual automation tailored to both individual preferences and systemic requirements.

FIG. 9 is a schematic diagram illustrating a client device showing an example embodiment of a client device that may be used within the present disclosure. Client device 900 may include many more or less components than those shown in FIG. 9. However, the components shown are sufficient to disclose an illustrative embodiment for implementing the present disclosure. Client device 900 may represent, for example, UE 102 discussed above at least in relation to FIG. 1.

As shown in the figure, in some embodiments, Client device 900 includes a processing unit (CPU) 922 in communication with a mass memory 930 via a bus 924. Client device 900 also includes a power supply 926, one or more network interfaces 950, an audio interface 952, a display 954, a keypad 956, an illuminator 958, an input/output interface 960, a haptic interface 962, an optional global positioning systems (GPS) receiver 964 and a camera(s) or other optical, thermal or electromagnetic sensors 966. Device 900 can include one camera/sensor 966, or a plurality of cameras/sensors 966, as understood by those of skill in the art. Power supply 926 provides power to Client device 900.

Client device 900 may optionally communicate with a base station (not shown), or directly with another computing device. In some embodiments, network interface 950 is sometimes known as a transceiver, transceiving device, or network interface card (NIC).

Audio interface 952 is arranged to produce and receive audio signals such as the sound of a human voice in some embodiments. Display 954 may be a liquid crystal display (LCD), gas plasma, light emitting diode (LED), or any other type of display used with a computing device. Display 954 may also include a touch sensitive screen arranged to receive input from an object such as a stylus or a digit from a human hand.

Keypad 956 may include any input device arranged to receive input from a user. Illuminator 958 may provide a status indication and/or provide light.

Client device 900 also includes input/output interface 960 for communicating with external. Input/output interface 960 can utilize one or more communication technologies, such as USB, infrared, Bluetooth™, or the like in some embodiments. Haptic interface 962 is arranged to provide tactile feedback to a user of the client device.

Optional GPS transceiver 964 can determine the physical coordinates of Client device 900 on the surface of the Earth, which typically outputs a location as latitude and longitude values. GPS transceiver 964 can also employ other geo-positioning mechanisms, including, but not limited to, triangulation, assisted GPS (AGPS), E-OTD, CI, SAI, ETA, BSS or the like, to further determine the physical location of client device 900 on the surface of the Earth. In an embodiment, however, client device 900 may through other components, provide other information that may be employed to determine a physical location of the device, including for example, a MAC address, Internet Protocol (IP) address, or the like.

Mass memory 930 includes a RAM 932, a ROM 934, and other storage means. Mass memory 930 illustrates another example of computer storage media for storage of information such as computer readable instructions, data structures, program modules or other data. Mass memory 930 stores a basic input/output system (“BIOS”) 940 for controlling low-level operation of Client device 900. The mass memory also stores an operating system 941 for controlling the operation of Client device 900.

Memory 930 further includes one or more data stores, which can be utilized by Client device 900 to store, among other things, applications 942 and/or other information or data. For example, data stores may be employed to store information that describes various capabilities of Client device 900. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 900.

Applications 942 may include computer executable instructions which, when executed by Client device 900, transmit, receive, and/or otherwise process audio, video, images, and enable telecommunication with a server and/or another user of another client device. Applications 942 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In some embodiments, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
collecting, by an application executing on a device at a location, telemetry and contextual data from devices within a network at the location;
analyzing, by the application, aggregated telemetry, the analysis comprising the application executing an AI/ML processing pipeline operating within a local edge infrastructure;
determining, by the application, a set of configuration parameters for the network based on the analysis;
generating, by the application, configuration outputs expressed as structured control commands; and
executing, by the application, deployment of the structured control commands through local management channels of the network.

2. The method of claim 1, wherein the telemetry and contextual data comprises physical layer metrics and medium access control layer statistics.

3. The method of claim 1, wherein the analyzing the aggregated telemetry comprising identifying complex temporal and spatial correlations across the network.

4. The method of claim 1, wherein the analysis includes anomaly detection and segmentation of client behavior.

5. The method of claim 1, wherein the determining the set of configuration parameters comprises minimizing co-channel and adjacent-channel interference and maximizing spectral efficiency.

6. The method of claim 1, wherein the structured control commands comprise updated radio configurations and client steering rules.

7. The method of claim 1, further comprising storing raw input telemetry and derived optimization artifacts within a database accessible to the application.

8. The method of claim 1, wherein the AI/ML processing pipeline is trained incrementally, adapting to evolving conditions of the network.

9. The method of claim 1, wherein the collected telemetry and contextual data comprises information related to non-Wi-Fi signals and spectral anomalies.

10. The method of claim 1, wherein the network is a Wi-Fi network.

11. A device comprising:
a processor; and
memory tangibly storing computer instructions, that when executed, cause the processor to:
collect, by an application executing on the device at a location, telemetry and contextual data from devices within a network at the location;
analyze, by the application, aggregated telemetry, the analysis comprising the application executing an AI/ML processing pipeline operating within a local edge infrastructure;
determine, by the application, a set of configuration parameters for the network based on the analysis;
generate, by the application, configuration outputs expressed as structured control commands; and
execute, by the application, deployment of the structured control commands through local management channels of the network.

12. The device of claim 11, wherein the telemetry and contextual data comprises physical layer metrics and medium access control layer statistics.

13. The device of claim 11, wherein the analyzing the aggregated telemetry comprising identifying complex temporal and spatial correlations across the network.

14. The device of claim 11, wherein the analysis includes anomaly detection and segmentation of client behavior.

15. The device of claim 11, wherein the determining the set of configuration parameters comprises minimizing co-channel and adjacent-channel interference and maximizing spectral efficiency.

16. The device of claim 11, wherein the structured control commands comprise updated radio configurations and client steering rules.

17. The device of claim 11, wherein the processor is further caused to store raw input telemetry and derived optimization artifacts within a database accessible to the application.

18. The device of claim 11, wherein the AI/ML processing pipeline is trained incrementally, adapting to evolving conditions of the network.

19. The device of claim 11, wherein the collected telemetry and contextual data comprises information related to non-Wi-Fi signals and spectral anomalies.

20. A non-transitory computer-readable storage medium tangibly encoded with computer-executable instructions, that when executed by a device, perform a method comprising:
collecting, by an application executing on the device at a location, telemetry and contextual data from devices within a network at the location;
analyzing, by the application, aggregated telemetry, the analysis comprising the application executing an AI/ML processing pipeline operating within a local edge infrastructure;
determining, by the application, a set of configuration parameters for the network based on the analysis;
generating, by the application, configuration outputs expressed as structured control commands; and
executing, by the application, deployment of the structured control commands through local management channels of the network.
